(19) United States
(12) Patent Application Publication
(10) Pub. No.: US 2016/0061786 A1
(43) Pub. Date: Mar. 3, 2016

(54) COMPOSITIONAL ANALYSIS OF HIGH BOILING POINT MIXTURES BY COMPREHENSIVE TWO-DIMENSIONAL GAS CHROMATOGRAPHY

(71) Applicant: Frank Cheng-Yu Wang, Annandale, NJ (US)

(72) Inventor: Frank Cheng-Yu Wang, Annandale, NJ (US)

(73) Assignee: ExxonMobil Research and Engineering Company, Annandale, NJ (US)

(21) Appl. No.: 14/471,496

(22) Filed: Aug. 28, 2014

(51) Int. Cl. G01N 30/02; B01D 53/04

(52) U.S. Cl. CPC G01N 30/02; B01D 53/0407; B01D 2257/702; B01D 2256/24; G01N 2030/025

(57) ABSTRACT

The thermally modulated, two-dimensional gas chromatographic separation of a mixture of compounds with boiling points higher than 260° C. uses a cold trap with a gas jet at ambient temperatures.

### FIELD OF THE INVENTION

This invention relates to comprehensive two-dimensional gas chromatography (2DGC or GC×GC).

### BACKGROUND OF THE INVENTION

Comprehensive two-dimensional gas chromatography, usually referred to as GC×GC, is a recently developed technique for the analysis of multi-component mixtures by a double separation process in which the sample to be analyzed is passed in turn through two chromatography columns (the two dimensions) under different separation conditions. In GC×GC two columns with different stationary phases are located in the same or separate GC ovens and are connected sequentially with a modulator positioned between them. Typically the first dimension is a non-polar column of conventional dimensions and the second dimension is a short, fast column, typically polar. Samples are normally injected at the head of the first column and after isolation and separation by the modulator, fractions are passed to the second column where further separation of the isolated fractions takes place according to a different chromatographic criterion. A detector or detectors such as flame ionization detector (FID), sulfur, nitrogen, chemiluminescence detector (SCD,NCD), and/or mass spectrometer detector (MSD) is/are located at the exit of the second column.

The modulator operates by collecting the effluent from the first column and transfers fractions of the effluent to the second column. The most frequently used type of modulation is the thermal modulation in which liquid nitrogen is used to cryogenically trap the components eluting from the first column. After a fixed time interval, a hot pulse is used to release a fraction of the retained eluate and pass it into the second column. An appropriate modulation time is selected for the modulator for the transfer of the first dimension eluate fractions into the second column for sampling (trapping and releasing) the first dimension peaks. The modulation time is typically of the order of seconds and transfers fractions which generate a series of 2D retention times.

The thermal modulation most used in practice is a liquid nitrogen system that provides modulation temperatures low enough to permit the separation of volatile mixtures. The cold jet used in the thermal modulated GC×GC is always introduced to a coolant such as liquid nitrogen or liquid carbon dioxide. Typically the temperature at the nitrogen jet is −189° C. A second type of low temperature modulator eliminates the need for liquid nitrogen and uses a refrigerator/heat exchanger to produce a jet of gaseous nitrogen at temperatures of the order of −90° C. at the jet. The hot jet used is nitrogen gas passed through a heater block heated to the desired high temperature which will be selected in accordance with the volatility of the sample but typically will not exceed about 450° C.

The GC×GC technique is widely needed in many different applications but the application is limited to centralized research laboratories with highly trained operators due to its complicated instrumentation, complex experimental procedures, and heavy resource dependence. A well-developed method that utilizes easier operational procedures and processes will greatly help to enable this technology to be accepted to more applications.

### SUMMARY OF THE INVENTION

According to the present invention, a thermally modulated GC×GC method for the analysis of a sample of a mixture of compounds with boiling points higher than 500° F. (or 260° C.) uses a cold gas jet at room temperature (below 104° F. or 40° C.) for thermal modulation. The gas may be, for example, nitrogen, air, carbon dioxide, or any non-toxic gas or combination of gases. The use of the room temperature gas as a cold jet will greatly reduce the resources (such as coolant of liquid nitrogen or liquid carbon dioxide) and temperature, coolant level, and coolant flow control equipment required to operate the GC×GC experiment and simplify the experimental processes and procedures.

The use of a room temperature gas used as a cold jet in the GC×GC method will greatly reduce the equipment required to operate the GC×GC experiment. It will also simplify the GC×GC experimental processes and procedures. From a resource dependence point of view, a GC×GC with a room temperature cold jet will completely be independent from the coolant requirement and coolant re-fill operation, which means this unit can be deployed to a regional test center or a production site, such as a refinery or a manufacturing factory. From an ease of operation point of view, simplifying the GC×GC experimental processes and procedures will mean that the GC×GC can be operated as routine equipment with standard operating procedures by workers from the field.

### DRAWINGS

In the accompanying drawings:

FIG. 1 is a 2D chromatogram of a lubricating oil sample using room temperature nitrogen as a cold jet in the modulator.

FIG. 2 is a 2D chromatogram of a vacuum gas oil sample using room temperature nitrogen as a cold jet in the modulator.

### DETAILED DESCRIPTION

The present invention using ambient temperature isolation in the modulator is applicable to high boiling mixtures such as any type of petroleum refined streams as well as any organic, biological, and polymeric mixtures. It finds application in the petroleum refining industry in the separation of gas oils, especially vacuum gas oils which typically boil in the range of about 315 to 540° C., more commonly from about 350 to 500° C. Hydrocarbon fractions in this boiling range do not require the very low temperatures of a cryogenic trap and can therefore be isolated effectively using a cold trap at ambient temperatures. The same temperatures are also effective for other mixtures of compounds, permitting a wide range of materials to be subjected to the GC×GC method.

The resulting chromatograms can be converted to generate a simulated distillation comparable to that prescribed by ASTM D2887 but including additional information about the boiling point distribution of the various components in the fraction. The total yield and sub-total yield of pre-defined compound classes as a function of boiling point may be generated by the method described in U.S. patent application Ser. No. 13/021,061, filed 4 Feb. 4, 2011. The 2D (2DGC or GC×GC) simulated distillation results will provide more information than traditional 1D simulation distillation results especially in the different compound classes by boiling point. In this way, the results may be used to generate a two-dimensional simulation distillation profile with weight percentage of separated compound class with temperature as well as a weight percentage plot of separated compounds by compound class and a plot of the weight percentage distribution of carbon number group within each compound class for the entire sample. From this, the weight percentages of individual separated components in the sample may be determined.

### EXAMPLE 1

A sample of a lubricating oil was tested by thermally modulated GC×GC with room temperature nitrogen as a cold jet. One end of 2D column forms loop modulation, and the other end was direct into an FID.

Experimental conditions:
Instrument: Agilent Technologies 6890 Series GC
Injector: Split/Splitless in Split Mode
Injector Temp: 300° C.
Column flow: 2 mL/min in constant flow mode

Split ratio: 1:10
Sample injection: Agilent ALS-Injection volume 0.2 μL
Modulator: Thermal modulator, single jet loop type (ZOEX Corporation)
Cold Jet: Room temperature nitrogen gas
N2 Flow rate approx.: 5L/min, controlled by a flow meter
Modulation time: 10 sec
Pulse width: 400 ms
Detector: Flame-ionization
FID Temperature: 300° C.
Makeup gas: He
Makeup flow: 20 mL/min
Hydrogen flow: 40 mL/min
Air flow: 450 mL/min
Column 1: 30 m×0.25 mm i.d. 5% phenyldimethylpolysiloxane column (BPX-5) with film thickness of 1.0 μm
Column 2: 2 m×0.25 mm polysilphenylene-siloxane column (BPX-50) with film thickness of 0.25 μm
Carrier gas: Helium
Oven temperature: 170° C. (0 min isothermal) then 2.0° C./min to 390° C.
Hot Jet: 250° C. (0 min temperature isothermal) then 2.0° C./min to 390° C. (40 min isothermal)

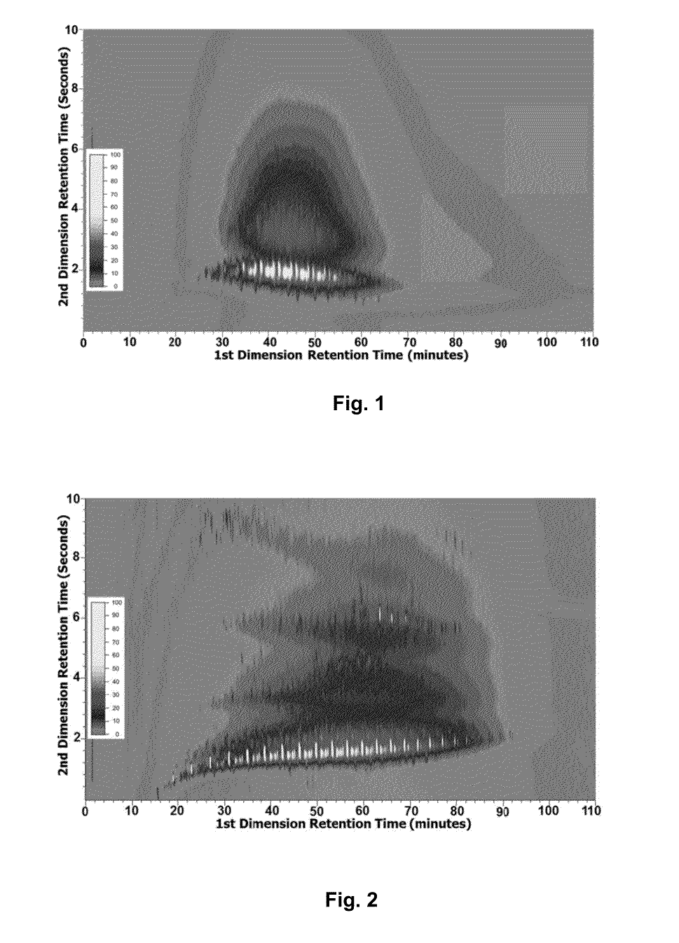

FIG. 1 shows the GC×GC chromatogram of using room temperature cold jet thermal modulation.

### EXAMPLE 2

A vacuum gas oil sample (315 to 540° C.) was tested by thermally modulated GC×GC with room temperature nitrogen as a cold jet. The experimental conditions were the same as in Example 1.

FIG. 2 shows the vacuum gas oil GC×GC chromatogram using room temperature cold jet thermal modulation.

Although both experiments used a cold gas jet at afar higher temperature than the normal liquid nitrogen-cooled or refrigerated jets, the separation of the components in the second dimension was demonstrated the acceptability of the technique more than adequately.

1. In a method for the thermally modulated, two-dimensional gas chromatography separation of a sample comprising a mixture of compounds with boiling points higher than 260° C., the improvement comprising the use of a cold trap with a room temperature gas jet.

2. A method according to claim in which the cold trap gas jet is at a temperature below 40° C.

3. A method according to claim 1 in which the cold trap gas jet is nitrogen, air, carbon dioxide.

4. A method according to claim 1 in which the sample mixture is a hydrocarbon mixture.

5. A method according to claim 1 which includes generating a two-dimensional simulation distillation profile with weight percentage of separated compound class with temperature.

6. A method according to claim 1 which includes generating a weight percentage plot of separated compounds by compound class.

7. A method according to claim 6 which includes generating a plot of weight percentage distribution of carbon number group within each compound class.

8. A method according to claim 6 which includes generating a weight percentage of individual separated components in the sample.
